(19) United States
(12) Patent Application Publication
(10) Pub. No.: US 2017/0108739 A1
(43) Pub. Date: Apr. 20, 2017

(54) LIQUID CRYSTAL DISPLAY DEVICE

(71) Applicant: SAMSUNG DISPLAY CO., LTD., Yongin-si (KR)

(72) Inventors: Beong Hun BEON, Hwaseong-si (KR); Hyeon Jeong SANG, Bucheon-si (KR); Eun Mi SEO, Cheonan-si (KR); Seung Beom PARK, Yongin-si (KR)

(21) Appl. No.: 15/134,599

(22) Filed: Apr. 21, 2016

(30) Foreign Application Priority Data
Oct. 19, 2015 (KR) 10-2015-0145074

(51) Int. Cl. G02F 1/13363; G02F 1/1339; G02F 1/1335

(52) U.S. Cl. CPC G02F 1/133634; G02F 1/133528; G02F 1/13363; G02F 1/133617; G02F 1/13394; G02F 2001/133637; G02F 2001/133614; G02F 2001/13398

(57) ABSTRACT

A liquid crystal display device includes a first polarizing film, a first compensation film on the first polarizing film, the first compensation film including a biaxial film, a second compensation film on the first compensation film, the second compensation film including a negative C-plate film, a substrate on the second compensation film, a liquid crystal layer on the substrate, a second polarizing film on the liquid crystal layer, and a color conversion filter on the second polarizing film.

### CROSS-REFERENCE TO RELATED APPLICATION

Korean Patent Application No. 10-2015-0145074, filed on Oct. 19, 2015, in the Korean Intellectual Property Office, and entitled: “Liquid Crystal Display Device,” is incorporated by reference herein in its entirety.

### BACKGROUND

1. Field

The present disclosure relates to a liquid crystal display device.

2. Description of the Related Art

A liquid crystal display device is one of flat panel display devices that are most widely used at present. The liquid crystal display device displays an image, by applying voltage to field generating electrodes, e.g., a pixel electrode and a common electrode disposed to interpose the liquid crystal layer therebetween, to generate an electric field in a liquid crystal layer, and by determining an alignment direction of the liquid crystal molecules of the liquid crystal layer and controlling the polarization of incident light.

### SUMMARY

According to an exemplary embodiment, there is provided a liquid crystal display device including a first polarizing film, a first compensation film disposed on the first polarizing film, a second compensation film disposed on the first compensation film, a substrate disposed on the second compensation film, a liquid crystal layer disposed on the substrate, a second polarizing film disposed on the liquid crystal layer, and a color conversion filter disposed on the second polarizing film, wherein the first compensation film is formed of a biaxial film, and the second compensation film is formed of a negative C-plate film.

A sum of thickness direction phase delay values Rth of the first compensation film and the second compensation film may be 100 nm or more and 350 nm or less.

The first compensation film may have an in-plane phase delay value R0 in a range of 20 nm or more and 80 nm or less, and a thickness direction phase delay value Rth in a range of 160 nm or more and 180 nm or less.

The second compensation film may have an in-plane phase delay value R0 in the range of (−10) nm or more and 10 nm or less, and a thickness direction phase delay value Rth in a range of 35 nm or more and 55 nm or less.

The liquid crystal display device may further include a light source unit below the first polarizing plate to provide light to the first polarizing plate, the light being blue light.

A peak wavelength of the light may be 440 nm or more and 460 nm or less.

The first compensation film and the second compensation film may include at least one of tri-acetyl-cellulose (TAC), cyclic olefin polymer (COP) series, and acrylic polymer resin.

The first compensation film may include at least one of tri-acetyl-cellulose (TAC), cyclic olefin polymer (COP) series, and acrylic polymer resin, and the second compensation film includes a disc-type liquid crystal.

The substrate may include a fine space layer supported by a support layer, the liquid crystal layer being in the fine space layer.

A common electrode may be positioned over the support layer, and a pixel electrode is positioned below the liquid crystal layer.

The color conversion filter may further include quantum dot particles.

According to another exemplary embodiment, there is provided a liquid crystal display device including a first polarizing film, a first compensation film disposed on the first polarizing film, a second compensation film disposed on the first compensation film, a substrate disposed on the second compensation film, a liquid crystal layer disposed on the substrate, a second polarizing film disposed on the liquid crystal layer, and a color conversion filter disposed on the second polarizing film, wherein the first compensation film is formed of a negative C-plate film, and the second compensation film is formed of a biaxial film.

A sum of thickness direction phase delay values Rth of the first compensation film and the second compensation film may be 100 nm or more and 350 nm or less.

The first compensation film may have an in-plane phase delay value R0 in the range of (−10) nm or more and 10 nm or less, and a thickness direction phase delay value Rth in a range of 35 nm or more and 55 nm or less.

The second compensation film may have an in-plane phase delay value R0 in a range of 20 nm or more and 80 nm or less, and a thickness direction phase delay value Rth in a range of 160 nm or more and 180 nm or less.

According to yet another exemplary embodiment, there is provided a liquid crystal display device including a first polarizing film, a first compensation film disposed on the first polarizing film, a substrate disposed on the first compensation film, a liquid crystal layer disposed on the substrate, a second compensation film disposed on the liquid crystal layer, a second polarizing film disposed on the second compensation film, and a color conversion filter disposed on the second polarizing film, wherein the first compensation film is formed of a biaxial film, and the second compensation film is formed of a negative C-plate film.

The first compensation film may include at least one of tri-acetyl-cellulose (TAC), cyclic olefin polymer (COP) series, and acrylic polymer resin, and the second compensation includes a disc-type liquid crystal.

A sum of thickness direction phase delay values Rth of the first compensation film and the second compensation film may be 100 nm or more and 350 nm or less.

The first compensation film may have an in-plane phase delay value R0 in a range of 20 nm or more and 80 nm or less, and a thickness direction phase delay value Rth in a range of 160 nm or more and 180 nm or less.

The second compensation film may have an in-plane phase delay value R0 in a range of (−10) nm or more and 10 nm or less, and a thickness direction phase delay value Rth in a range of 35 nm or more and 55 nm or less.

### BRIEF DESCRIPTION OF THE DRAWINGS

Features will become apparent to those of ordinary skill in the art by describing in detail exemplary embodiments with reference to the attached drawings, in which:

FIG. 1 illustrates a layout diagram of some pixels of a liquid crystal display device according to an embodiment;

FIG. 2 illustrates a cross-sectional view taken along line I-I′ of FIG. 1;

FIG. 3 illustrates a cross-sectional view taken along line II-II′ of FIG. 1;

FIG. 4 illustrates a cross-sectional view of three adjacent pixels of the liquid crystal display device according to an embodiment;

FIG. 5 illustrates a cross-sectional view of the three adjacent pixels of a liquid crystal display device according to another embodiment;

FIG. 6 illustrates a graph of a Poincare sphere illustrating a polarization state along a path of light that has passed through the liquid crystal display device illustrated in FIGS. 1 to 3;

FIG. 7 illustrates a graph of an appearance in which the Poincare sphere of FIG. 6 is viewed from a direction opposite to a direction of progress of an S1-axis;

FIG. 8 illustrates a cross-sectional view along a line corresponding to line II-II′ of FIG. 1 of the liquid crystal display device according to another embodiment;

FIG. 9 illustrates a graph of a Poincare sphere illustrating a polarization state along a path of light that has passed through the liquid crystal display device illustrated in FIG. 8;

FIG. 10 illustrates a graph of an appearance in which the Poincare sphere of FIG. 9 is viewed from a direction opposite to the direction of progress of the S1-axis;

FIG. 11 illustrates a cross-sectional view taken along a line corresponding to line II-II′ of FIG. 1 of a liquid crystal display device according to another embodiment;

FIG. 12 illustrates a graph of a Poincare sphere illustrating a polarization state along a path of light that has passed through the liquid crystal display device illustrated in FIG. 11; and

FIG. 13 illustrates a graph of an appearance in which the Poincare sphere of FIG. 12 is viewed from a direction opposite to the direction of progress of the S1-axis.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

It will be understood that, although the terms first, second, third, etc., may be used herein to describe various elements, these elements should not be limited by these terms. These terms are only used to distinguish one element from another element. Thus, a first element discussed below could be termed a second element without departing from the teachings of the disclosure.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Hereinafter, embodiments will be described with reference to the attached drawings.

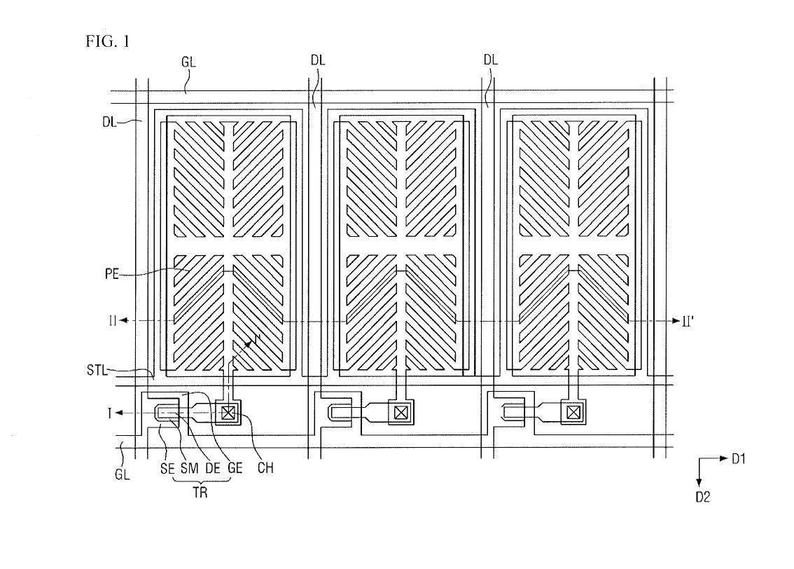

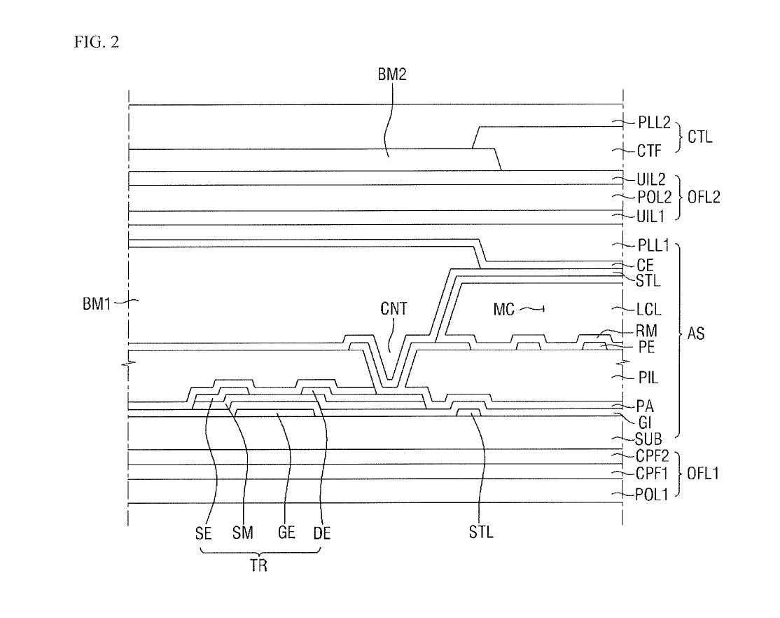

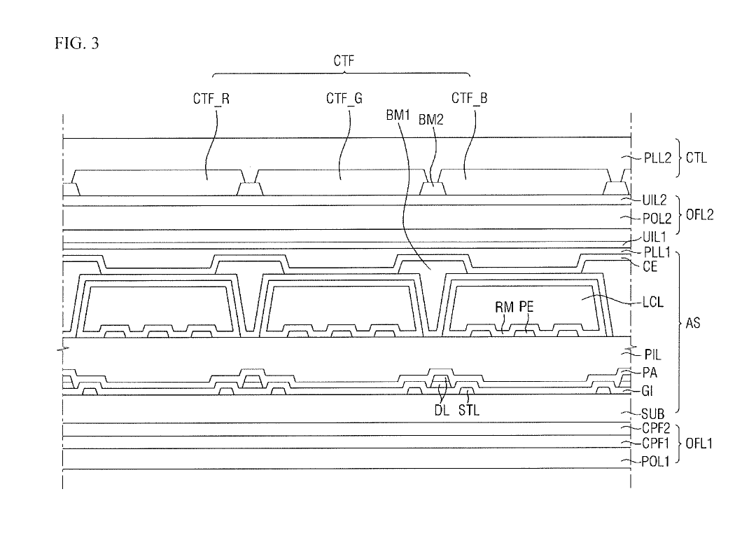

FIG. 1 is a layout diagram of some pixels of a liquid crystal display device according to an embodiment, FIG. 2 is a cross-sectional view taken along the line I-I′ of FIG. 1, and FIG. 3 is a cross-sectional view taken along the line II-II′ of FIG. 1.

Referring to FIGS. 1 to 3, a liquid crystal display device according to an embodiment may include a first optical film layer OFL1, an array substrate AS, a second optical film layer OFL2, and a color conversion layer CTL. The array substrate AS is a thin film transistor array substrate AS, in which thin film transistors TR for driving the liquid crystal molecules of a liquid crystal layer LCL are formed. First and second optical film layers OFL1 and OFL2 are layers for controlling the optical characteristics of light that passes from the bottom to the top of the array substrate AS. The color conversion layer CTL is a layer for controlling the color of light that passes from the bottom to the top of the array substrate AS.

Hereinafter, the array substrate AS will be described in detail.

The array substrate AS may include a base substrate SUB. The base substrate SUB may be a transparent insulating substrate. For example, the base substrate SUB may be made of a glass substrate, a quartz substrate, a transparent resin substrate or the like. In addition, the base substrate SUB may also include a polymer or plastic having high heat resistance. Although the base substrate SUB may be a flat structure, e.g., with a planar surface, it may be curved in a particular direction. Although the base substrate SUB may have a rectangular shape having four sides in the plan view, it may also have other polygonal structures or circular structures, or may have a structure in which a part of the sides is a curved line.

The base substrate SUB may also be a flexible substrate. That is, the base substrate SUB may be a substrate which can be deformed by rolling, folding, bending or the like.

Gate wirings GL, GE including a plurality of gate lines GL and gate electrodes GE are disposed on the base substrate SUB. The gate lines GL may transmit gate signals and may extend in a first direction D1.

For example, the gate wirings GL, GE may contain an aluminum-based metal, e.g., aluminum (Al) and an aluminum alloy, a silver-based metal such as silver (Ag) or a silver alloy, a copper-based metal such as copper (Cu) or a copper alloy, a molybdenum-based metal such as molybdenum (Mo) or a molybdenum alloy, chromium (Cr), tantalum (Ta) and titanium (Ti). The gate wirings GL, GE may be a single-layer structure or may be a multi-layer structure including at least two conductive layers with different physical properties. Among them, a conductive film may be made of a low-resistance metal, e.g., an aluminum metal, a silver-based metal and a copper-based metal so as to be able to reduce a signal delay or a voltage drop of the gate wirings GL, GE. In contrast, other conductive films may be made of materials with excellent contact characteristics with other materials, in particular, indium tin oxide (ITO) and indium zinc oxide (IZO), for example, a molybdenum-based metal, chromium, titanium, tantalum, etc. Examples of the combinations thereof may include a chromium lower film and an aluminum upper film, and an aluminum lower film and a molybdenum upper film. However, the present disclosure is not limited thereto, and the gate wirings GL, GE may be formed various metals and conductors.

The gate electrode GE may be formed in a shape that protrudes from the gate line GL.

A gate insulating layer GI may be placed over the gate wirings GL, GE. The gate insulating layer GI may be made of an insulating material. For example, the gate insulating layer GI may be made of silicon nitride, silicon oxide, silicon oxynitride or a high dielectric constant material. The gate insulating layer GI may be made up of a single-layer structure or may have a multi-layer structure including two insulating layers with different physical properties.

A semiconductor layer SM may be disposed over the gate insulating layer GI. The semiconductor layer SM may be disposed to at least partially overlap the gate electrode GE. The semiconductor layer SM may include, e.g., amorphous silicon, polycrystalline silicon or oxide semiconductor.

An ohmic contact member may be further disposed over the semiconductor layer. The ohmic contact may be formed of n+hydrogenated amorphous silicon doped with an n-type impurity at high concentration or silicide. The ohmic contact members may be disposed on the semiconductor layer SM in pairs. When the semiconductor layer SM is an oxide semiconductor, the ohmic contact member may be omitted.

Data wirings DL, SE may be disposed over the semiconductor layer SM and the gate insulating layer GI. The data wirings DL, SE may include a data line DL and a source electrode SE.

The data line DL transmits data signals, extends in a second direction D2 intersecting with the first direction D1 and may intersect with the gate line GL. The source electrode SE branches and protrudes from the data line DL, and the drain electrode DE may be disposed by being spaced apart from the source electrode SE. The source electrode SE and the drain electrode DE overlaps the semiconductor layer SM or is in contact with the semiconductor layer SM, and the source electrode SE and the drain electrode DE may be disposed to face each other with the semiconductor layer SM interposed therebetween. At least one of the source electrode SE and the drain electrode DE may be disposed to partially overlap the gate electrode GE, but it is not limited thereto.

The data wirings DL, DE may be formed of aluminum, copper, silver, molybdenum, chromium, titanium, tantalum or alloys thereof, and may also have a multilayered structure that includes a lower film (not illustrated) such as a refractory metal and a low-resistance upper film (not illustrated) formed thereon, but it is not limited thereto.

The gate electrode GE, the source electrode SE, the drain electrode DE and the semiconductor layer SM form a single thin film transistor TR, and a channel of the thin film transistor TR is formed between the source electrode SE and the drain electrode DE of the semiconductor layer SM. The thin film transistor TR is electrically connected to the gate line GL and data line DL.

A protective layer PA may be disposed over the gate insulating layer GI and the thin film transistor TR. The protective layer PA may be made of, e.g., an inorganic insulating material and may cover the thin film transistor TR.

A pixel insulating layer PIL may be disposed over the protective layer PA. The pixel insulating layer PIL may flatten the top of the protective layer PA and may be made of an organic material. For example, the pixel insulating layer PIL may be made of a photosensitive organic composition. However, the pixel insulating layer PIL may be omitted.

A contact hole CNT may be formed on the protective layer PA and the pixel insulating layer PIL to expose a part of the thin film transistor TR, i.e., a part of the drain electrode DE. The contact hole CNT may serve as a passage through which the drain electrode DE disposed below the protective layer PA and other elements placed over the pixel insulating layer PIL are physically connected to each other.

The pixel electrode PE is disposed over the pixel isolation layer PIL. The pixel electrode PE is partially and physically connected to the drain electrode DE through the contact hole CNT and may receive application of a voltage from the drain electrode DE. The pixel electrode may be made of a transparent conductive material, e.g., ITO, IZO, ITZO and AZO.

The pixel electrode PE is disposed for each pixel. In addition, each of the pixel electrodes PE may include a “+” shaped stem and a plurality of branches extending obliquely from the stem. In this case, slits serving as openings that are not filled with the pixel electrodes PE are formed among the plurality of stems. The pixel electrode PE has a specific pattern by the stem and the slits, and may control the arrangement of the liquid crystal molecules disposed on the liquid crystal layer LCL, by such a pattern and interaction with a common electrode CE to be described later.

A support layer STL may be disposed over the pixel electrode PE and the pixel insulating layer PIL. The support layer STL may serve as a support so that the interior of the support layer STL and an upper space (hereinafter, referred to as a fine space layer MC) of the pixel electrode PE and the pixel insulating layer PIL can be formed. The cross-section of the support layer STL may have a trapezoidal shape, and although it is not illustrated, the support layer STL may have a liquid crystal injection port on one side to inject the liquid crystal molecules into the fine space layer MC. The support layer STL may be formed of an inorganic insulating material, e.g., silicon nitride (SiNₓ).

An alignment film RM may be disposed on an inner wall of the fine space layer MC and at the top of the pixel electrode PE and the pixel insulating layer PIL. The alignment film RM may allow the liquid crystal molecules of the liquid crystal layer LCL disposed inside the fine space layer MC to be aligned in a particular direction even if a separate electric field is not formed. The alignment film RM may be formed of, e.g., polyamic acid, polysiloxane or polyimide.

The liquid crystal layer LCL may be disposed inside the alignment film RM of the fine space layer MC. The thickness of the liquid crystal layer LCL may be about 3 μm to about 6 μm, and may contain a plurality of liquid crystal molecules having dielectric anisotropy. The liquid crystal molecules may be vertically aligned liquid crystal molecules that are aligned in a direction approximately perpendicular to the array substrate AS. When an electric field is applied to the liquid crystal layer LCL, the liquid crystal molecules are tilted at a specific slope depending on the intensity of the electric field, thereby being able to deform the polarization state of light that passes through the liquid crystal layer LCL.

A first light-shielding member BM1 may be disposed between the adjacent support layers STL. The first light-shielding member BM1 may overlap the thin film transistors TR, the data lines DL, and the gate lines GL of each pixel, thereby blocking a light leakage caused by misalignment of the liquid crystal molecules or preventing components located on the base substrate SUB from being visually recognized by the user's eyes. The first light-shielding member BM1 may contain a material that does not transmit light.

A common electrode CE may be disposed over the support layer STL and the first light-shielding member BM1. The common electrode CE may be made of a transparent conductive material, e.g., ITO, IZO, ITZO and AZO, and may be formed over the entire surface of the base substrate SUB. A specific voltage may be applied to the common electrode CE, and the common electrode CE and the pixel electrode PE disposed to be spaced apart with the liquid crystal layer LCL interposed therebetween form an electric field, thereby being able to control the liquid crystal molecules.

A first planarization layer PLL1 may be disposed over the common electrode CE. The first planarization layer PLL1 is a layer for removing a step generated on the common electrode CE due to the first light-shielding member BM1, and may contain an organic material. However, the first planarization layer PLL1 may be omitted.

Next, the first optical film layer OFL1 will be described.

The first optical film layer OFL1 may be disposed on a rear surface of the array substrate AS, e.g., on a surface of the array substrate AS facing away from the liquid crystal layer LCL. The first optical film layer OFL1 may include a first polarizing film POL1, a first compensation film CPF1, and a second compensation film CPF2.

The first polarizing film POL1 may be disposed on the lowest part of the first optical film layer OFL1. The first polarizing film POL1 transmits only a specific polarized component of light incident from the bottom of the first polarizing film POL1 so that the light may have only a specific polarization.

The first compensation film CPF1 may be disposed on the first polarizing film POL1, and a second compensation film CPF2 may be disposed on the first compensation film CPF1. That is, the first compensation film CPF1 may be disposed between the first polarizing film POL1 and the second compensation film CPF2, e.g., the second compensation film CPF2 may be directly on the rear surface of the array substrate AS.

The first compensation film CPF1 and the second compensation film CPF2 may compensate for the refraction caused by anisotropy of the liquid crystal layer LCL to expand a viewing angle of the liquid crystal display device, and may improve a side visibility and a contrast ratio. In detail, the first compensation film CPF1 and the second compensation film CPF2 relax a deviation in the polarization states of light visually recognized when viewed from the front of the liquid crystal display device and when viewed from the side surface thereof, thereby improving the side visibility.

The first compensation film CPF1 may be formed of a biaxial film, and the second compensation film CPF2 may be formed of a negative C-plate film. Each of the first and second compensation films CPF1, CPF2 has values of the refractive indexes (nx, ny, nz) in the x-axis, y-axis and z-axis directions. In this case, the biaxial film satisfies a relation of refractive indexes of nx≠ny≠nz. In addition, the negative C-plate film satisfies a relation of the refractive indexes of nx=ny>nz.

Depending on the characteristics of the biaxial film and the negative C-plate film, each of the first compensation film CPF1 and the second compensation film CPF2 has a specific in-plane phase delay value R0 and a thickness direction phase delay value Rth. Specifically, each of the in-plane phase delay value R0 and the thickness direction phase delay value Rth is a value defined by Formula 1 and Formula 2 below, and where d is the thickness of the compensation film.

R0=(nx−ny)*d Formula 1

Rth=((nx+ny)/2 nz)*d Formula 2

Thus, in the first compensation film CPF1 formed of a biaxial film, both of the in-plane phase delay value R0 and the thickness direction phase delay value Rth may have values other than 0. In addition, the in-plane phase delay value R0 of the negative C-plate film may have a value of zero, and the thickness direction phase delay value Rth may have a value other than 0.

In detail, the sum of the thickness direction phase delay values Rth of the first compensation film CPF1 and the second compensation film CPF2 may be 100 nm or more and 350 nm or less. In this case, when light incident from the bottom of the first polarizing film POL1 is blue light, it is possible to effectively improve the side visibility of the liquid crystal display device.

Furthermore, the first compensation film CPF1 formed of a biaxial film may have an in-plane phase delay value R0 in the range of 20 nm or more and 80 nm or less, and may have a thickness direction phase delay value Rth in the range of 160 nm or more and 180 nm or less.

In addition, the second compensation film CPF2 formed of a negative C-plate film may have an in-plane phase delay value R0 in the range of about (−10) nm or more and about 10 nm or less. The second compensation film CPF2 may have a thickness direction phase delay value Rth in the range of 35 nm or more and 55 nm or less.

In this case, a peak wavelength of the blue light incident from the bottom of the first polarizing film POL1 may be about 440 nm or more and about 460 nm or less, and when satisfying all the above-mentioned conditions, a side visibility improvement effect of the liquid crystal display device may be maximized.

The first compensation film CPF1 and the second compensation film CPF2 may be formed of at least one of, e.g., tri-acetyl-cellulose (TAC), cyclic olefin polymer (COP) series and acrylic polymer resin. The acrylic polymeric resin may contain polymethylmethacrylate (PMMA).

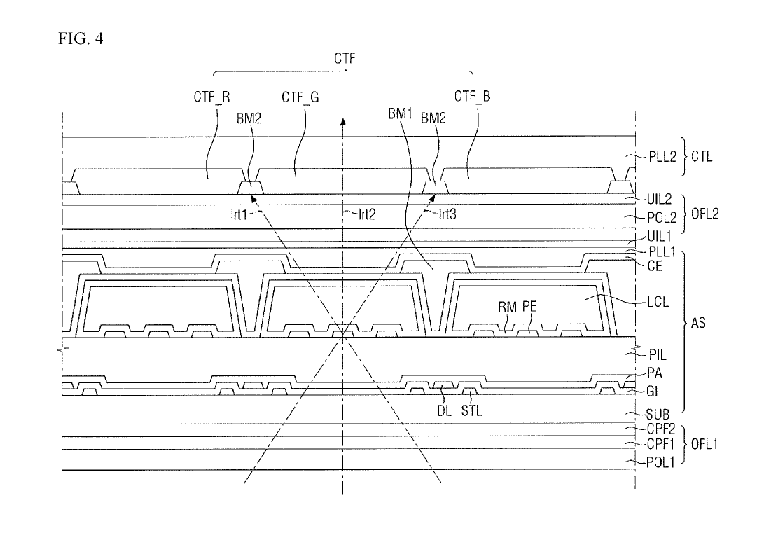

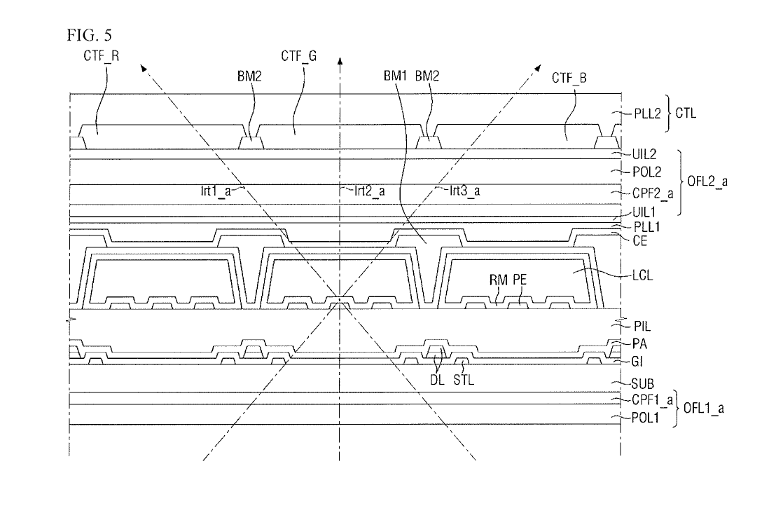

In addition, each of the thicknesses of the first and second compensation films CPF1, CPF2 may be 10 μm or more and 100 μm or less, e.g., the thicknesses may be in range between about 30 μm and about 50. Since both the first and second compensation films CPF1, CPF2 are disposed on the rear surface of the liquid crystal layer LCL, color mixing depending on the thicknesses of the first and second compensation films CPF1, CPF2 may not occur. The color mixing will be described in more detail below with reference to FIGS. 4 and 5.

Next, the second optical film layer OFL2 will be described.

The second optical film layer OFL2 may be disposed on the array substrate AS, and may include a first upper insulating layer UIL1, a second polarizing film POL2, and a second upper insulating layer UIL2. For example, the second polarizing film POL2 may be between the first and second upper insulating layers UIL1 and UIL2.

The first upper insulating layer UIL1 may be disposed, e.g., directly, on the first planarization layer PLL1, and may be formed of an inorganic insulating material, e.g., silicon nitride (SiNₓ). The first upper insulating layer UIL1 may insulate the first planarization layer PLL1, the components disposed in the rear direction of the first planarization layer PLL1, and the components over the first upper insulating layer UIL1. However, the first upper insulating layer UIL1 may also be omitted.

The second polarizing film POL2 on the first upper insulating layer UIL1 transmits only a specific polarized component of light incident from the bottom of the second polarizing film POL2 so that the light has only a specific polarization. At this time, depending on the polarization state of the light provided from the bottom, all the light may pass through the second polarizing film POL2, and all the light may be blocked by the second polarizing film POL2. The second polarizing film POL2 may be thin to prevent color mixing between adjacent pixels, e.g., may have a thickness of about 100 μm or more and about 200 μm or less.

The second upper insulating layer UIL2 may be disposed on the second polarizing film POL 2. The second upper insulating layer UIL2 may be formed of the same material as the first upper insulating layer UIL1 and may perform the same role. Further, a color conversion layer CTL to be described later is disposed on the second upper insulating layer UIL2, and may be manufactured to have sufficient durability to form these layers. However, the second upper insulating layer UIL2 may also be omitted.

Next, the color conversion layer CTL will be described.

The color conversion layer CTL may include a second light-shielding member BM2, a color conversion filter CTF, and a second planarization layer PLL2.

The second light-shielding member BM2 may be disposed, e.g., directly, on the second upper insulating layer UIL2. The second light-shielding member BM2 may contain a material that does not transmit light, and may prevent color mixing between adjacent pixels. The color mixing will be described below with reference to FIGS. 4 and 5.

The second light-shielding member BM2 has an opening, which may correspond to a region where the pixel electrodes of each pixel PE are formed.

The color conversion filter CTF may be disposed on the second light-shielding member BM2. The color conversion filter CTF may allow light incident from the bottom to have a specific color. In detail, when the liquid crystal display device displays an image through red, green, and blue as three primary colors of light, i.e., when the liquid crystal display device includes red pixels for displaying red, green pixels for displaying green and blue pixels for displaying blue, the color conversion filter CTF may include a red color conversion filter CTF_R, a green color conversion filter CTF_G. and a blue color conversion filter CTF_B. The red color conversion filter CTF_R may allow the passing light to have red and may be formed in the pixel for displaying red, the green color conversion filter CTF_G may allow the passing light to have green and may be formed in the pixel for displaying green, and the blue color conversion filter CTF_B may allow the passing light to have blue and may be formed in the pixel for displaying blue.

However, in the case of some embodiments, a transparent color conversion filter CTF_T in place of the blue color filter may be formed at a position where the blue color conversion filter CTF is disposed. The transparent color conversion filter CTF_T may not convert the color of incident light. Nevertheless, the pixel formed with the transparent color conversion filter CTF_T may display blue. The reason is that light provided below the transparent color conversion filter CTF_T is blue light.

The red color conversion filter CTF_R may contain red quantum dot (QD) particles, and converts blue light provided from a blue light source into red. Also, the green color conversion filter CTF_G may contain green quantum dot (QD) particles, and converts the blue light provided from the blue light source into green. However, the quantum dot particles contained in each color conversion filter CTF correspond to a representative example of a luminant, and luminant other than the quantum dot may also be included.

The transparent color conversion filter CTF_T contains scattering particles that change the direction of progress of the blue light, without converting the color of the blue light provided from the blue light source. The scattering particles may be particles, e.g., TiO₂ particles, and their sizes may also be equivalent to the red quantum dot particles or the green quantum dot particles.

In this embodiment, after light provided through the bottom of the first optical film layer OFL1, the array substrate AS, the second optical film layer OFL2, and the color conversion layer CTL is scattered from the red quantum dot particles, the green quantum dot particles, and the scattering particles, the light is emitted to the outside to display an image. Thus, since the direction of progress of light emitted to the outside is wide and a gradation of light does not change depending on the positions, the light can have a wide viewing angle.

The color conversion filter CTF extends long along a row or a column of the pixel electrode PE, and the pixels of the same color may be disposed in the first direction D1 or the second direction D2. Depending on the embodiments, one or more of cyan, magenta, yellow, and white-series colors may also be displayed, rather than the three primary colors of red, green and blue light.

A second planarization layer PLL2 may be disposed on the second light-shielding member BM2 and the color conversion filter CTF. The second planarization layer PLL2 may relax or remove a step that occurs due to the second light-shielding member BM2 and the color conversion filter CTF. The second planarization layer PLL2 may be formed of an organic material, and in some cases, it may have durability of constant strength to protect the components formed below the second planarization layer PLL2. However, the second planarization layer PLL2 may also be omitted depending on the embodiments.

During manufacturing of the liquid crystal display device described above, the array substrate AS may be formed first. Next, the first optical film layer OFL1 and the second optical film layer OFL2 may be attached to each of an upper surface and a rear surface of the completed array substrate AS. After attachment of the first and second optical film layers OFL1, OFL2, the color conversion layer CTL may be patterned and formed at the top of the second optical film layer OFL2.

According to the liquid crystal display device as described above, color mixing between adjacent pixels may be reduced, e.g., as compared to a liquid crystal display device of a general structure. This will be described in more detail below with reference to FIGS. 4 and 5.

FIG. 4 is a cross-sectional view of three adjacent pixels of the liquid crystal display device according to an embodiment, and FIG. 5 is a cross-sectional view of three adjacent pixels of a liquid crystal display device according to another embodiment. The cross-sectional views illustrated in FIGS. 4 and 5 are equivalent to the cross-sectional view taken along a line corresponding to line II-II′ of FIG. 1.

The liquid crystal display devices of FIGS. 4 and 5 are different from each other in the position of the second compensation film CPF2. That is, the liquid crystal display device illustrated in FIG. 4 includes the second compensation film CPF2 in the first optical film layer OFL1, while the liquid crystal display device illustrated in FIG. 5 includes a second compensation film CPF2_a in a second optical film layer OFL2_a.

Thus, the thickness of the second compensation film CPF2 layer of the liquid crystal display device illustrated in FIG. 4 may be thinner than the thickness of the second compensation film CPF2_a layer of the liquid crystal display device illustrated in FIG. 5. Consequently, since a distance between the liquid crystal layer LCL and the color conversion layer CTL is shorter in the liquid crystal display device illustrated in FIG. 4 than in the liquid crystal display device illustrated in FIG. 5, color mixing may be less visually recognized in the liquid crystal display device illustrated FIG. 4.

In detail, the color mixing is a phenomenon in which other colors as well as a color to be displayed are mixed and visually recognized. This may occur when the light incident on a certain pixel passes through the color conversion filter CTF of an adjacent pixel, rather than passing only through the color conversion filter CTF of the certain pixel.

For example, in the case of the liquid crystal display device illustrated in FIG. 5, light progressing through a second optical path lrt2_a passes through a single pixel electrode PE and a single color conversion filter CTF_G, so the color mixing does not occur. However, even though light progressing through the first optical path lrt1_a passes via a pixel electrode PE corresponding to the green color conversion filter CTF_G, the actual first optical path lrt1_a may pass through the red color conversion filter CTF_R of the adjacent pixel, thereby allowing some red light components be visible with the green light components. In this case, if color mixing occurs, the display quality may be lowered. This is also true for the case of light along the third optical path lrt3_a.

In contrast, in the case of the liquid crystal display device illustrated in FIG. 4, the distance between the array substrate AS and the color conversion layer CTL is relatively short. As such, light progressing through a second optical path lrt2 passes only through a single pixel electrode PE and a single color conversion filter CTF_G, so the color mixing does not occur. Further, in the case of light progressing through the first optical path lrt1, the light is blocked by the second light-shielding member BM2 disposed in the color conversion layer CTL. Therefore, the color mixing may be less visually recognized. Similarly, in the case of the light progressing through the third sight lrt3, the light is blocked by the second light-shielding member BM2 disposed in the color conversion layer CTL, and the color mixing may be less visually recognized.

Hereinafter, polarization of light passing through the first compensation film CPF1, the second compensation film CPF2, and the liquid crystal layer LCL will be described.

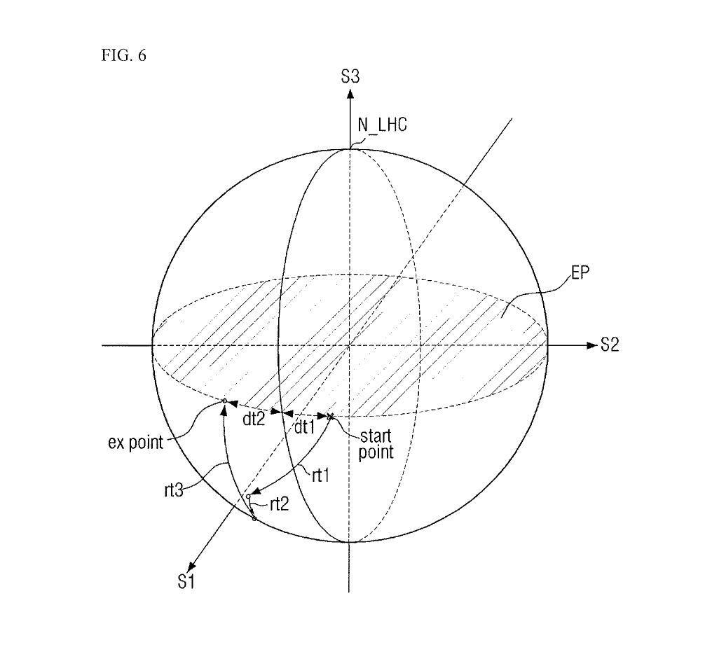

FIG. 6 is a graph illustrating a Poincare sphere illustrating a polarization state along a path of light that has passed through the liquid crystal display device illustrated in FIGS. 1 to 3, and FIG. 7 is a graph illustrating a state in which the Poincare sphere of FIG. 6 is viewed from a direction opposite to the direction of progress of the S1-axis.

The Poincare sphere as described herein is a chart of the observer standards at an azimuth angle of 45° and a poloidal angle of 60° in which the liquid crystal display device is viewed from the front. In addition, the Poincare sphere as described herein is a representation of a polarization state at coordinates of a three-dimensional space based on Stokes parameter. Further, a northern hemisphere of the Poincare sphere is a left-handed circle (LHC), and a southern hemisphere of the Poincare sphere is a right-handed circle (RHC).

In addition, as it approaches the poles (N_LHC, R_LHC) of the Poincare sphere, it approaches a circular polarization state, and as it approaches an equatorial plane EP, it approaches a linear polarization state.

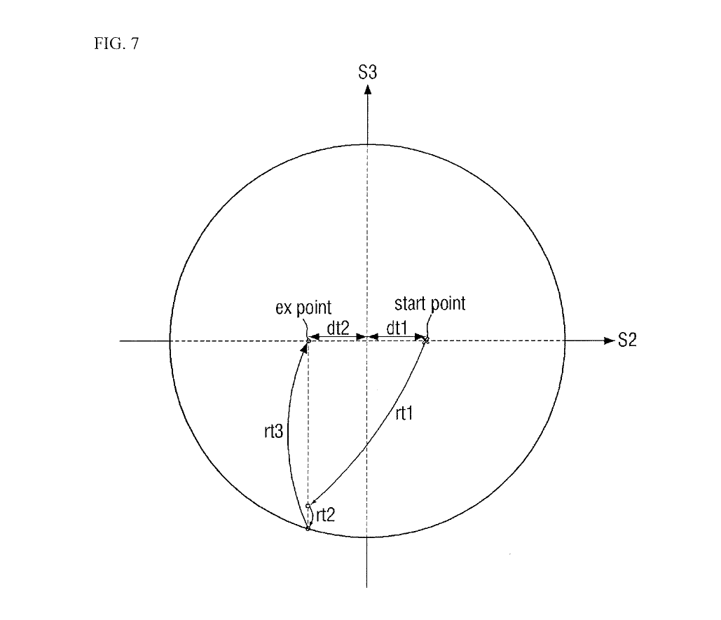

Referring to FIGS. 6 and 7, the light passing through the liquid crystal display device according to an embodiment of the present disclosure sequentially passes through the first compensation film CPF1, the second compensation film CPF2, and the liquid crystal layer LCL, and the polarization state changes so that the light moves along the first path rt1, the second path rt2, and the third path rt3 along the surface of the Poincare sphere.

This embodiment describes a structure in which the first compensation film CPF1 is a biaxial film and the second compensation film CPF2 is a negative C-plate film, as an example.

First, the light which has passed through the first polarizing film POL1 has a polarization state corresponding to a start point represented by character ‘x’. Next, the light passes through the first compensation film CPF1, and the Poincare sphere polarization state moves along the first path rt1 and approaches the circular polarization state.

Next, the light passes through the second compensation film CPF2, and the Poincare sphere polarization state moves along the second path rt2 and approaches a further circular polarization state. At this time, when passing through the second compensation film CPF2, movement of the polarization state in a direction parallel to the S2-axis is hardly observed, and meanwhile, when passing through the first compensation film CPF1, significant movement of the polarization state in the direction parallel to the S2-axis is observed. Furthermore, the movement distance of the direction parallel to the S3-axis when passing through the first compensation film CPF1 may be greater than the movement distance in the direction parallel to the S3-axis when passing through the second compensation film CPF2.

Next, the light passes through the liquid crystal layer LCL, and the Poincare sphere polarization state moves to an erasing point (Ex point) along the third path rt3 and approaches the linear polarization state. Accordingly, since the erasing point (Ex point) in the polarization state of the light that has passed through the first compensation film CPF1, the second compensation film CPF2, and the liquid crystal layer LCL is located on the equatorial plane EP, even when viewed from the side, the linear polarization can be achieved, and the side visibility can be improved.

Further, the distance between the plane including the S1-axis and the S3-axis measured along the outer periphery of the equatorial plane EP has a first distance dt1 in the case of the start point, and in the case of the erasing point (Ex point), the distance has a second distance dt2. The first distance dlt and the second distance dt2 may have the same value. When the first distance dt1 and the second distance dt2 have the same value, it is possible to have an optimum contrast ratio even when the liquid crystal display device is viewed from the side.

As a result, as described above, it is possible to understand that, even when the first compensation film CPF1 and the second compensation film CPF2 are continuously disposed so as to be adjacent to each other, the side visibility and the contrast ratio of the liquid crystal display device can be properly compensated.

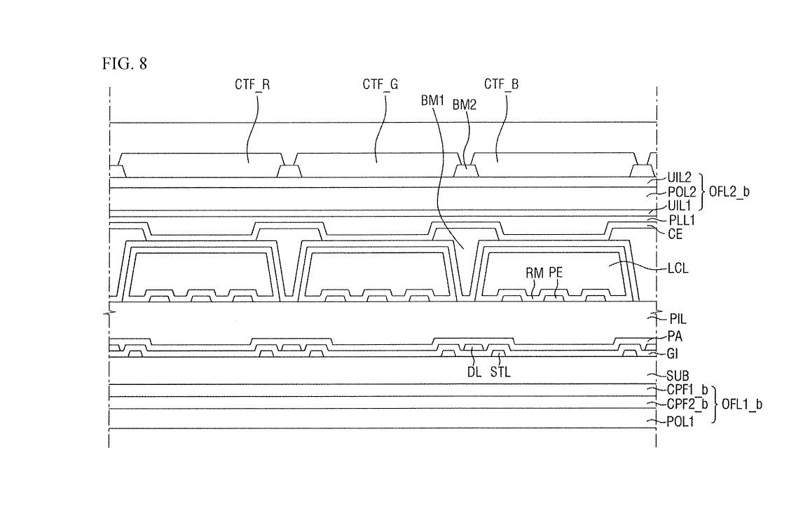

FIG. 8 is a cross-sectional view taken along a line corresponding to line II-II′ of FIG. 1 of a liquid crystal display device according to another embodiment of the present disclosure. In the following example, the same configurations as the above-described configurations are denoted by the same reference numerals, and repeated description will be omitted or simplified.

Referring to FIG. 8, the first optical film layer OFL1_b includes a first polarizing film POL1, a second compensation film CPF2_b, and a first compensation film CPF1_b. However, unlike the embodiment illustrated in FIG. 3 in which the first polarizing film POL1, the first compensation film CPF1, and the second compensation film CPF2 are sequentially laminated, in this embodiment, the second compensation film CPF2_b is disposed on the first polarizing film POL1, and the first compensation film CPF1_b is located on the second compensation film CPF2_b. Thus, the first polarizing film POL1, the second compensation film CPF2_b, and the first compensation film CPF1_b are sequentially disposed. That is, as compared to the embodiment illustrated in FIG. 3, the first compensation film CPF1_b and the second compensation film CPF2_b may be disposed so that their positions change, e.g., reversed.

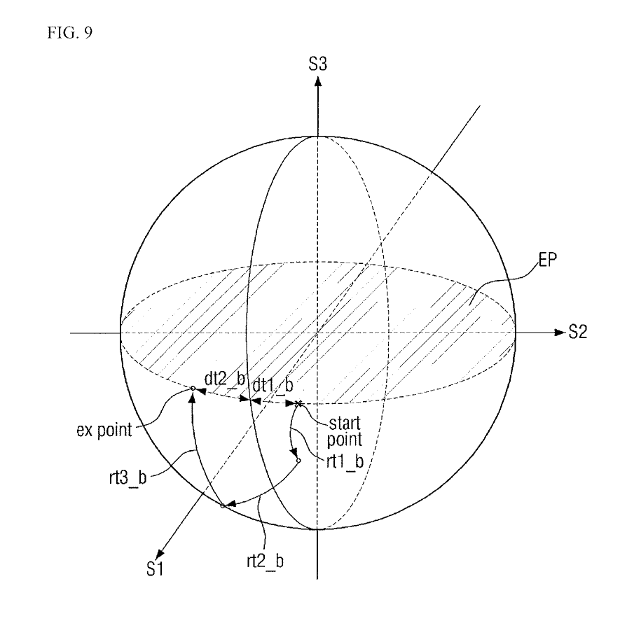

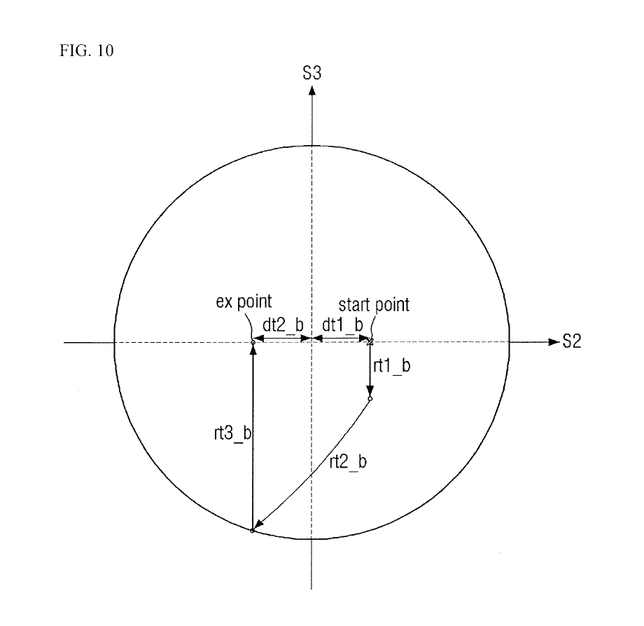

Therefore, the light that is incident from the bottom of the first optical film layer OFL1_b and passes through the first optical film layer OFL1_b sequentially passes through the first polarizing film POL1, the second compensation film CPF2_b, and the first compensation film CPF1_b, and the polarization state changes depending on the respective disposed films. At this time, since the first compensation film CPF1_b is formed of a biaxial film and the second compensation film CPF2_b is formed of a negative C-plate film, a change in the polarization of light may change in a different way from that of the embodiment illustrated in FIG. 3. However, like the embodiment illustrated in FIG. 3, in the case of this embodiment, it is also possible to improve the side visibility of the liquid crystal display device. This will be described in more detail with reference to FIGS. 9 and 10.

FIG. 9 is a graph illustrating the Poincare sphere illustrating a polarization state along a path of light that has passed through the liquid crystal display device illustrated in FIG. 8, and FIG. 10 is a graph illustrating an appearance in which the Poincare sphere of FIG. 9 is viewed from a direction opposite to the direction of progress of the S1-axis.

Referring to FIGS. 9 and 10, light passing through the liquid crystal display device illustrated in FIG. 8 sequentially passes through the second compensation film CPF2_b, the first compensation film CPF1_b, and the liquid crystal layer LCL, and the polarization state changes so that the light moves along the first path tr1_b, the second path rt2_b, and the third path rt3_b along the surface of the Poincare sphere.

First, the light which has passed through the first polarizing film POL1 has a polarization state corresponding to a start point represented by character ‘x’. Next, the light passes through the second compensation film CPF2_b, and the Poincare sphere polarization state moves along the first path rt1_b and approaches a circular polarization state.

Next, the light passes through the first compensation film CPF1_b, and the Poincare sphere polarization state moves along the second path rt2_b and approaches a further circular polarization state. At this time, when passing through the second compensation film CPF2_b, movement of the polarization state in a direction parallel to the S2-axis is hardly observed, and meanwhile, when passing through the first compensation film CPF1_b, significant movement of the polarization state in the direction parallel to the S2-axis is observed. Furthermore, the movement distance of the direction parallel to the S3-axis when passing through the first compensation film CPF1_b may be greater than the movement distance in the direction parallel to the S3-axis when passing through the second compensation film CPF2_b.

That is, when compared to FIGS. 6 and 7 illustrating a change in the polarization state of the liquid crystal display device of FIG. 3, in both embodiments, changes in the polarization state of light when passing through each of the first compensation film CPF1_b are identical to each other, and changes in the polarization state of light when passing through each of the second compensation film CPF2_b may be identical to each other. Thus, in both embodiments, the polarization state of the light after passing through the first and second compensation films (CPF1, CPF2, CPF1_b and CPF2_b) may have the same polarization state, regardless of the passage order of the first and second compensation films (CPF1, CPF2, CPF1_b and CPF2_b). That is, a position of a point indicating the polarization state of the light passed through the first path rt1 and the second path rt2 in FIGS. 6 and 7 may be the same as a position of a point indicating the polarization state of light passing through the first path rt1_b and the second path rt2_b in FIGS. 9 and 10.

Next, the light passing through the second compensation film CPF2_b and the first compensation film CPF1_b passes through the liquid crystal layer LCL, and the Poincare sphere polarization state moves to an erasing point (Ex point) along the third path rt3_b and approaches a linear polarization state. Since the position of the erasing point of light which has moved along the first to third paths (rt1_b, rt2_b and rt3_b) is the same as the position of the erasing point (Ex point) illustrated in FIGS. 6 and 7, as described above, it is possible to improve the side visibility and the contrast ratio of the liquid crystal display device.

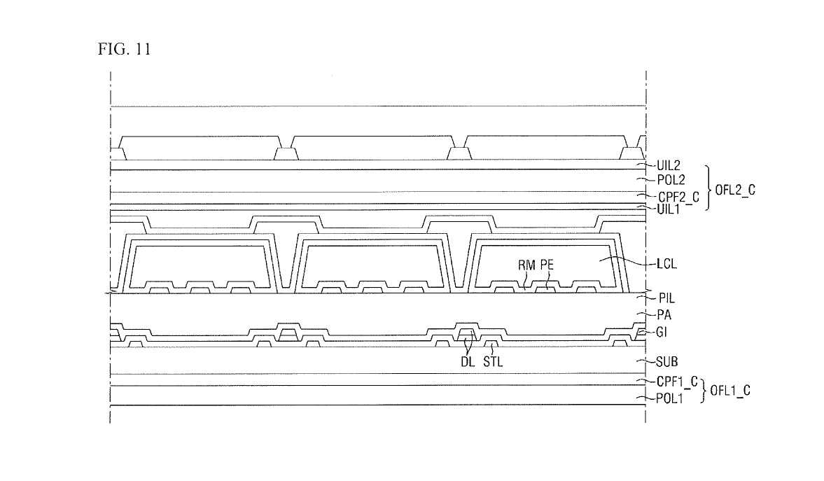

FIG. 11 is a cross-sectional view taken along a line corresponding to line II-II′ of FIG. 1 of a liquid crystal display device according to another embodiment of the present disclosure.

Referring to FIG. 11, a first optical film layer OFL1_c includes a first polarizing film POL1 and a first compensation film CPF1_c, and a second optical film layer OFL2_c includes a second compensation film CPF2_c and a second polarizing film POL2. That is, in this embodiment, unlike the embodiment illustrated in FIG. 3 in which both the first and second compensation films CPF1, CPF2 are disposed in the first optical film layer OFL1, the first compensation film CPF1_c may be included in the first optical film layer OFL1_c, and the second compensation film CPF2_c may be included in the second optical film layer OFL2_c.

As described above, in order to prevent color mixing in the liquid crystal display device, the thinner the thickness of the second optical film layer OFL2_c is, the better. Thus, despite arrangement of the second compensation film CPF2_c on the second optical film layer OFL2_c, in order to minimize the thickness of the second optical film layer OFL2_c, the second compensation film CPF2_c may be formed of other materials other than a stretched film formed of triacetyl cellulose, cycloolefin polymer-based and acrylic polymer resin. That is, in the liquid crystal display of the present embodiment, the second compensation film CPF2_c may be formed of a liquid crystal film.

The liquid crystal film may be manufactured, by applying a polymerizable liquid crystal compound on a layer on which the liquid crystal film is to be formed, and by curing the compound by being irradiated with ultraviolet rays after drying. When forming the liquid crystal film by the manufacturing method, the film may have a thickness of about 3 μm or more and about 5 μm or less, unlike the stretched film that generally has a thickness of 10 μm or more and 100 μm or less.

Therefore, even if the second compensation film CPF2_c is formed on the second optical film layer OFL2_c, the second compensation film CPF2_c may be formed to have a thickness smaller than that of a conventional second compensation film formed of the stretched film. Thus, since the thickness of the second optical film layer OFL2_c becomes thinner, it is possible to minimize the color mixing between the adjacent pixels. Furthermore, there is also an effect of being able to reduce the overall thickness of the liquid crystal display device due to a decrease in thickness of the second compensation film CPF2_c itself.

Even in the case of the embodiment illustrated in FIG. 3 in which the second compensation film CPF2 is disposed on the first compensation film CPF1, the second compensation film CPF2 may also be formed of a liquid crystal film, without being limited thereto. A disc-type liquid crystal may be used as the liquid crystal film in this example. The disc-type liquid crystal has a plate-like structure and may be a structure in which the disc-type molecules are stacked on a vertical axis. Since the disc-type liquid crystal has a viewing angle improvement effect, it may also be used in a wide viewing angle film, and since the disc-type liquid crystal has an electron transporting capability, it may be also used as an organic conductor.

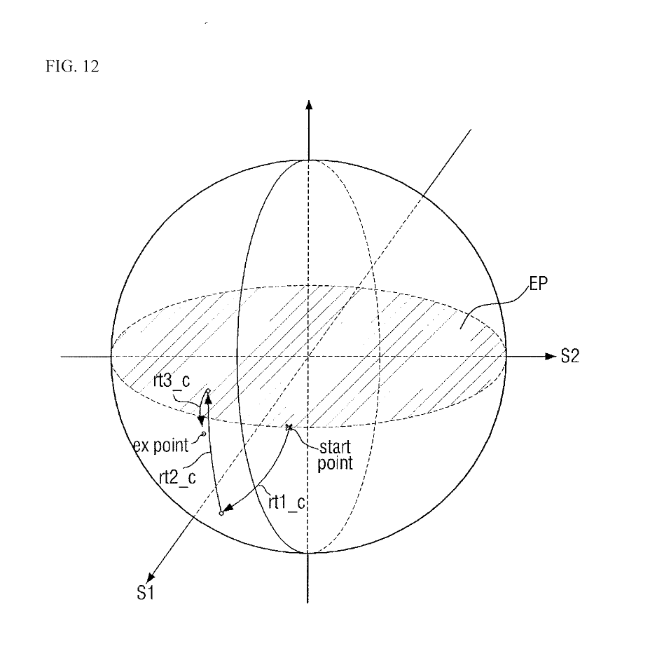

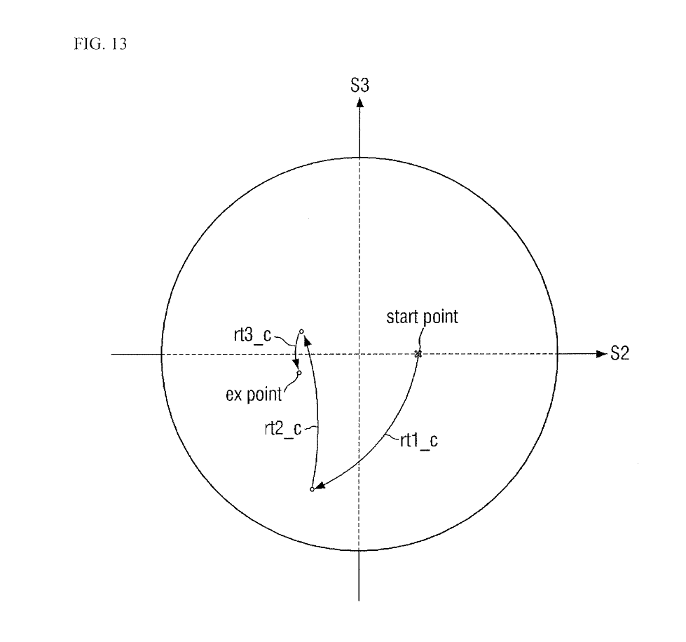

FIG. 12 is a graph illustrating a Poincare sphere illustrating a polarization state along a path of light that has passed through the liquid crystal display device illustrated in FIG. 11, and FIG. 13 is a graph illustrating an appearance in which the Poincare sphere in FIG. 12 is viewed from a direction opposite to the direction of progress of the S1-axis.

First, the light which has passed through the first polarizing film POL1 has a polarization state corresponding to a start point represented by character ‘x’. Next, the light passes through the first compensation film CPF1, and the Poincare sphere polarization state moves along the first path rt1_c and approaches the circular polarization state.

Next, the light passes through the liquid crystal layer LCL, and the Poincare sphere polarization state moves along the second path rt2_c and approaches a further circular polarization state. Next, the light passes through the second compensation film CPF2, and the Poincare sphere polarization state moves to an erasing point (Ex point) along the third path rt3_C and further approaches the linear polarization state.

However, unlike the previous embodiments, since the second compensation film CPF2_c is formed of a liquid crystal film, the erasing point (Ex point) may not be formed on the equatorial plane EP, but the erasing point may be generally disposed near the equatorial surface EP. Also, a distance from the start point to a plane defined by the S1 and S3-axes may be generally the same as a distance from the erasing point (Ex point) to a plane defined by the S1 and S3-axes. Therefore, it is possible to improve the side visibility and the contrast ratio of the liquid crystal display device.

By way of summation and review, a liquid crystal display device uses a color filter to display color, and a structure that contains an illuminant as a material of the color filter. When the illuminant is contained in the color filter, the viewing angle of the liquid crystal display device may be increased, while power consumption may be decreased. However, the display quality may be lowered due to the color mixing between adjacent pixels, depending on the arrangement structure of the components that control the polarization of the incident light. In contrast, example embodiments provide a liquid crystal display device in which degradation in display quality due to color mixing is minimized.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A liquid crystal display device, comprising:
a first polarizing film;
a first compensation film on the first polarizing film, the first compensation film including a biaxial film;
a second compensation film on the first compensation film, the second compensation film including a negative C-plate film;
a substrate on the second compensation film;
a liquid crystal layer on the substrate;
a second polarizing film on the liquid crystal layer; and
a color conversion filter on the second polarizing film.

2. The liquid crystal display device as claimed in claim 1, wherein a sum of thickness direction phase delay values Rth of the first compensation film and the second compensation film is 100 nm or more and 350 nm or less.

3. The liquid crystal display device as claimed in claim 2, wherein the first compensation film has an in-plane phase delay value R0 in a range of 20 nm or more and 80 nm or less, and a thickness direction phase delay value Rth in a range of 160 nm or more and 180 nm or less.

4. The liquid crystal display device as claimed in claim 2, wherein the second compensation film has an in-plane phase delay value R0 in the range of (−10) nm or more and 10 nm or less, and a thickness direction phase delay value Rth in a range of 35 nm or more and 55 nm or less.

5. The liquid crystal display device as claimed in claim 2, further comprising a light source unit below the first polarizing plate to provide light to the first polarizing plate, the light being blue light.

6. The liquid crystal display device as claimed in claim 5, wherein a peak wavelength of the light is 440 nm or more and 460 nm or less.

7. The liquid crystal display device as claimed in claim 1, wherein the first compensation film and the second compensation film include at least one of tri-acetyl-cellulose (TAC), cyclic olefin polymer (COP) series, and acrylic polymer resin.

8. The liquid crystal display device as claimed in claim 1, wherein the first compensation film includes at least one of tri-acetyl-cellulose (TAC), cyclic olefin polymer (COP) series, and acrylic polymer resin, and the second compensation film includes a disc-type liquid crystal.

9. The liquid crystal display device as claimed in claim 1, wherein the substrate includes a fine space layer supported by a support layer, the liquid crystal layer being in the fine space layer.

10. The liquid crystal display device as claimed in claim 9, wherein a common electrode is positioned over the support layer, and a pixel electrode is positioned below the liquid crystal layer.

11. The liquid crystal display device as claimed in claim 1, wherein the color conversion filter further comprises quantum dot particles.

12. A liquid crystal display device, comprising:
a first polarizing film;
a first compensation film on the first polarizing film, the first compensation film including a negative C-plate film;
a second compensation film on the first compensation film, the second compensation film including a biaxial film;
a substrate on the second compensation film;
a liquid crystal layer on the substrate;
a second polarizing film on the liquid crystal layer; and
a color conversion filter on the second polarizing film.

13. The liquid crystal display device as claimed in claim 12, wherein a sum of thickness direction phase delay values Rth of the first compensation film and the second compensation film is 100 nm or more and 350 nm or less.

14. The liquid crystal display device as claimed in claim 13, wherein the first compensation film has an in-plane phase delay value R0 in the range of (−10) nm or more and 10 nm or less, and a thickness direction phase delay value Rth in a range of 35 nm or more and 55 nm or less.

15. The liquid crystal display device as claimed in claim 13, wherein the second compensation film has an in-plane phase delay value R0 in a range of 20 nm or more and 80 nm or less, and a thickness direction phase delay value Rth in a range of 160 nm or more and 180 nm or less.

16. A liquid crystal display device, comprising:
a first polarizing film;
a first compensation film on the first polarizing film, the first compensation film including a biaxial film;
a substrate on the first compensation film;
a liquid crystal layer on the substrate;
a second compensation film on the liquid crystal layer, the second compensation film including a negative C-plate film;
a second polarizing film on the second compensation film; and
a color conversion filter on the second polarizing film.

17. The liquid crystal display device as claimed in claim 16, wherein the first compensation film includes at least one of tri-acetyl-cellulose (TAC), cyclic olefin polymer (COP) series, and acrylic polymer resin, and the second compensation includes a disc-type liquid crystal.

18. The liquid crystal display device as claimed in claim 16, wherein a sum of thickness direction phase delay values Rth of the first compensation film and the second compensation film is 100 nm or more and 350 nm or less.

19. The liquid crystal display device as claimed in claim 18, wherein the first compensation film has an in-plane phase delay value R0 in a range of 20 nm or more and 80 nm or less, and a thickness direction phase delay value Rth in a range of 160 nm or more and 180 nm or less.

20. The liquid crystal display device as claimed in claim 18, wherein the second compensation film has an in-plane phase delay value R0 in a range of (−10) nm or more and 10 nm or less, and a thickness direction phase delay value Rth in a range of 35 nm or more and 55 nm or less.
